(19) United States
(12) Patent Application Publication
(10) Pub. No.: US 2017/0134195 A1
(43) Pub. Date: May 11, 2017

(54) METHOD AND DEVICE FOR RADIO FREQUENCY CONTROL OF MULTICHANNEL WIRELESS MODEM

(71) Applicant: LEAUTO INTELLIGENT TECHNOLOGY (BEIJING) CO. LTD, Chaoyang District Beijing (CN)

(72) Inventors: Wenlong HAN, Chaoyang District Beijing (CN); Bo CHENG, Chaoyang District Beijing (CN)

(21) Appl. No.: 14/978,221

(22) Filed: Dec. 22, 2015

(30) Foreign Application Priority Data
Nov. 9, 2015 (CN) 201510755492X

(51) Int. Cl. H04L 25/49; H04B 15/00

(52) U.S. Cl. CPC H04L 25/4917; H04B 15/00

(57) ABSTRACT

The present disclosure provides a method. and device for radio frequency control of a multichannel wireless modem. The multichannel wireless modem includes N wireless modems, and the method includes: sorting the N wireless modems; acquiring a registering frequency of the 1st wireless modem; for the nth wireless modem, calculating an interfering frequency of the nth wireless modem according to registering frequencies of the 1st to the (n−1)th wireless modems, and registering according to a frequency retrieved by the nth wireless modem to obtain the registering frequency of the nth wireless modem, wherein the registering frequency does not fall into frequency scope of the interfering frequency; starting to execute the step from n=2 and finishing till n=N. The present disclosure achieves that the registering frequencies of the N wireless modems are different, thus avoids co-channel interference and frequency doubling interference and improves sensitivity and transmission rate of the multichannel wireless modem.

### CROSS-REFERENCE TO RELATED APPLICATIONS

This application is based upon and claims priority to Chinese Patent Application No. 201510755492.X, titled “method and device for radio frequency control of multichannel wireless modem”, filed on Nov. 9, 2015, the entire contents of which are incorporated herein by reference.

### FIELD OF TECHNOLOGY

The present disclosure generally relates to a technical field of communication, and more particularly to a method and device for radio frequency control of a multichannel wireless modem.

### BACKGROUND

In order to increase speed of uploading and downloading, multichannel wireless modem products adopt a way of a plurality of modems working simultaneously. For current frequency bands allocated by operators, some of the frequency band of each operator is contiguous with one another, and frequencies are close. When each modem works simultaneously, they are limited by physical size of the products. Since the distance between antennas of each modem is very close, the antennas will interfere with one another, severely disturbing sensitivity of receivers and unable to achieve the purpose of increasing transmission rate. Because a plurality of modems might work at the same time, it is inevitable that the problem of a transmitter of a modem interfering with a receiver of another modem exists. Using principle of radio-frequency interference for explanation, signals of similar frequencies will be received by the receiver, thus the quality of the signals that need to be received will be influenced. On the other side, repeated harmonic wave will also influence receiving.

### SUMMARY

In view of aforesaid problem, the present disclosure is put forward to provide a method and device for radio frequency control of a multichannel wireless modem to overcome aforesaid problem or at least partly solve aforesaid problem.

According to one aspect of the present disclosure, the present disclosure provides a method for radio frequency control of a multichannel wireless modem. The multichannel wireless modem includes N wireless modems, and the method includes:

sorting the N wireless modems;

acquiring a registering frequency of the 1st wireless modem; and

for the nth wireless modem, calculating an interfering frequency of the nth wireless modem according to registering frequencies of the 1st to the (n−1)th wireless modems, and registering according to a frequency retrieved by the nth wireless modem to obtain the registering frequency of the nth wireless modem, wherein the registering frequency does not fall into frequency scope of the interfering frequency; starting to execute the step from n=2 and finishing till n=N.

Optionally, calculating an interfering frequency of the nth wireless modem according to registering frequencies of the 1st to the (n−1)th wireless modems further includes:

using an interfering frequency computational formula:

F=a₁f₁±a₂f₂±a₃f₃ . . . ±aₙ₋₁fₙ₋₁ to calculate the interfering frequency of the nth wireless modem according to the registering frequencies of the 1st to the (n−1)th wireless registering modems, wherein a₁+a₂+a₃ . . . aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems.

Optionally, the method also includes: inquiring whether a interfering frequency F has negative numbers or not, wherein the interfering frequency F is calculated according to the interfering frequency computational formula: F=a₁f₁±a₂f₂±a₃f₃ . . . ±aₙ₋₁fₙ₋₁, wherein a₁+a₂+a₃ . . . +aₙ₋₁23 5, a₁, a₂, a₃ . . . aₙ₋₁ are natural numbers and f₁, f₂, f₃ . . . fₙ₋₁ are the registering frequencies of the 1st to the (n−1)th wireless modems, and if the interfering frequency has negative numbers, deleting the negative interfering frequencies, and taking the rest interfering frequency F as the interfering frequency of the nth wireless modem.

Optionally, the registering frequency does not fall into frequency scope of the interfering frequency further includes that:

the registering frequency does not fall into the scope of a preset threshold value frequency band which takes the interfering frequency as center frequency.

Optionally, sorting the N wireless modems further includes:

sorting the N wireless modems according to a preset priority rule.

According to another aspect of the present disclosure, the present disclosure provides a device for radio frequency control of a multichannel wireless modem, the multichannel wireless modem includes N wireless modems, and the device includes:

a sorting module, configured to sort the N wireless modems;

an acquiring module, configured to acquire a registering frequency of the 1st wireless modem;

a calculating module, configured to calculate an interfering frequency of the nth wireless modem according to registering frequencies of the 1st to the (n−1)th wireless modems for the nth wireless modem;

a registering module, configured to register according to a frequency retrieved by the nth wireless modem to obtain the registering frequency of the nth wireless modem, wherein the registering frequency does not fall into frequency scope of the interfering frequency; starting to execute the step from n=2 and finishing till n=N.

Optionally, the calculating module is further configured to:

use an interfering frequency computational formula: F=a₁f₁±a₂f₂±a₃f₃ . . . ±aₙ₋₁fₙ₋₁ to calculate the interfering frequency of the nth wireless modem according to registering frequencies of the 1st to the (n−1)th wireless modems, wherein a₁+a₂+a₃ . . . +aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems.

Optionally, the device also comprises: an inquiring module, configured to inquire whether a interfering frequency F has negative numbers or not, wherein the interfering frequency F is calculated according to the interfering frequency computational formula: F=a₁f₁±a₂f₂±a₃f₃ . . . ±aₙ₋₁fₙ₋₁, wherein a₁+a₂+a₃ . . . +aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems;

a deleting module, configured to delete the negative interfering frequencies if the interfering frequency has negative numbers, and to take the rest interfering frequency F as the interfering frequency of the nth wireless modem.

Optionally, that the registering frequency does not fall into frequency scope of the interfering frequency further comprises that:

the registering frequency does not fail into the scope of a preset threshold value frequency band which takes the interfering frequency as center frequency.

Optionally, the sorting module is further configured to: sort the N wireless modems according to a preset priority rule.

According to another aspect of the present disclosure, the present disclosure provides a device for radio frequency control of a multichannel wireless modem, the multichannel wireless modem includes N wireless modems, and the device includes:

one or more processors: and

a memory; and

one or more programs, wherein one or more programs are stored in the memory, and when executed by the one or more processors, the one or more programs cause the one or more processors to perform:

sorting the N wireless modems;

acquiring a registering frequency of the 1st wireless modem;

for the nth wireless modem, calculating an interfering frequency of the nth wireless modem according to registering frequencies of the 1st to the (n−1)th wireless modems, and registering according to a frequency retrieved by the nth wireless modem to obtain a registering frequency of the nth wireless modem, wherein said registering frequency does not fall into a frequency scope of said interfering frequency; starting to execute the step from n=2 and finishing till n=N.

According to the scheme provided by the present disclosure, sorting the N wireless modems; acquiring the registering frequency of the 1st wireless modem: for the nth wireless modem, calculating the interfering frequency of the nth wireless modem according to registering frequencies of the 1st to the (n−1)th wireless modems, and registering according to a frequency retrieved by the nth wireless modem to obtain the registering frequency of the nth wireless modem, wherein the registering frequency does not fall into frequency scope of the interfering frequency: starting to execute the step from n=2 and finishing till n=N, the scheme achieves that the registering frequencies of the N wireless modems are different, thus avoids co-channel interference and frequency doubling interference and improves sensitivity and transmission rate of the multichannel wireless modem.

The above illustration is only a general description of the technical solutions provided by the present disclosure, aiming at making the technical means of the present disclosure understood more clearly and thereby practiced based on the contents of the specification. Further, in order to make the above and other objects, features and advantages of the present disclosure more obvious, specific implementations of the present disclosure will be exemplified below.

### BRIEF DESCRIPTION OF THE DRAWINGS

One of ordinary skill in this art will appreciate other advantages from the following detailed description of exemplary embodiments herein. Drawings are only for showing exemplary embodiments but not for limiting the scope of the present disclosure. Through the drawings, similar reference numbers represent similar elements.

FIG. 1 is a flowchart showing a method for radio frequency control of a multichannel wireless modem according to an embodiment of the present disclosure;

FIG. 2 is a flowchart showing a method for radio frequency control of a multichannel wireless modem according to another embodiment of the present disclosure;

FIG. 3 is a structure diagram of a device for radio frequency control of a multichannel wireless modem according to an embodiment of the present disclosure;

FIG. 4 is a structure diagram of a device for radio frequency control of a multichannel wireless modem according to an embodiment of the present disclosure;

FIG. 5 is a structure diagram of a device for radio frequency control of a multichannel wireless modem according to an embodiment of the present disclosure.

### DESCRIPTION OF THE EMBODIMENTS

Exemplary embodiments of the present disclosure will be described below in detail with reference to drawings. Even though exemplary embodiments of the present disclosure are presented in drawings, it shall be appreciated that the present disclosure may be practiced in various manners without being limited to the embodiments set forth herein. Instead, the embodiments are provided herein to make the present disclosure be understood more thoroughly and to more completely convey the scope of the present disclosure to one of ordinary skill in this art.

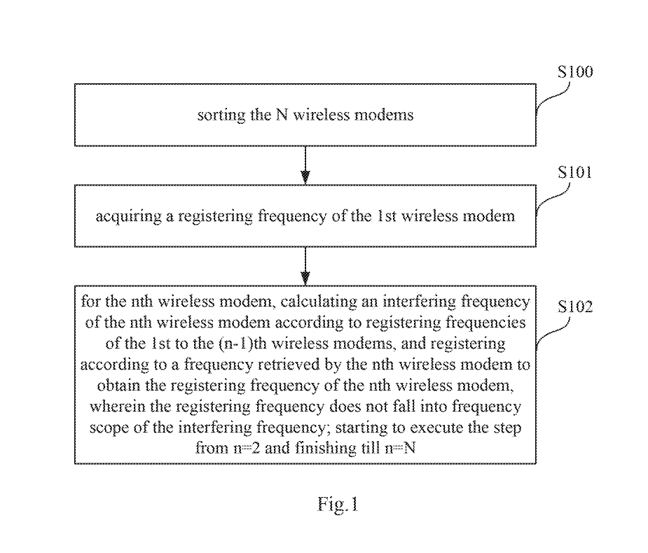

FIG. 1 is a flowchart showing a method for radio frequency control of a multichannel wireless modem according to an embodiment of the present disclosure. As is shown in FIG. 1, the method includes the following steps:

Step S100, sorting the N wireless modems.

Generally, a multichannel wireless modem includes N wireless modems. In order to conveniently obtain registering frequencies of each wireless modem, the embodiment sorts the N wireless modems, and the order is from 1 to N. The wireless modems will register according to the sorting order.

Step S101, acquiring a registering frequency of the 1st wireless modem.

After the N wireless modems are sorted according to the method in Step S100, the 1st wireless modem registers online, retrieving the registering frequency and allocating a frequency to the 1st wireless modem to acquire the registering frequency of the 1st wireless modem.

Step S102, for the nth wireless modem, calculating an interfering frequency of the nth wireless modem according to registering frequencies of the 1st to the (n−1)th wireless modems, and registering according to a frequency retrieved by the nth wireless modem to obtain the registering frequency of the nth wireless modem, wherein the registering frequency does not fall into frequency scope of the interfering frequency; starting to execute the step from n=2 and finishing till n=N.

Wherein the interfering frequency refers to the frequencies of useless signals interfering with a receiver of useful signals. In order to avoid the N wireless modems interfering with one another, the interfering frequencies of the N wireless modems need to be calculated, avoiding selecting the interfering frequencies for online registration.

Specifically, after acquiring the registering frequency of the 1st wireless modem, the interfering frequency of the 2nd wireless modem can be calculated according to the registering frequency of the 1st wireless modem. When the 2nd wireless modem registers online, its frequency scope capable of registering should be retrieved first. The frequency scope capable of registering retrieved by the 2nd wireless modem might include the calculated interfering frequency of the 2nd wireless modem. The 2nd wireless modem needs to avoid registering a frequency that falls into the frequency scope of the interfering frequency during online registration.

Execute the step repetitively until the registering frequency of the nth wireless modem is obtained. The embodiment achieves that the registering frequencies of the N wireless modems are different, thus avoids co-channel interference and frequency doubling interference.

According to the method provided by aforesaid embodiment of the present disclosure, sorting the N wireless modems; acquiring the registering frequency of the 1st wireless modem; for the nth wireless modem, calculating the interfering frequency of the nth wireless modem according to registering frequencies of the 1st to the (n−1)th wireless modems, and registering according to a frequency retrieved by the nth wireless modem to obtain the registering frequency of the nth wireless modem, wherein the registering frequency does not fall into frequency scope of the interfering frequency; starting to execute the step from n=2 and finishing till n=N, the method achieves that the registering frequencies of the N wireless modems are different, thus avoids co-channel interference and frequency doubling interference and improves sensitivity and transmission rate of the multichannel wireless modem.

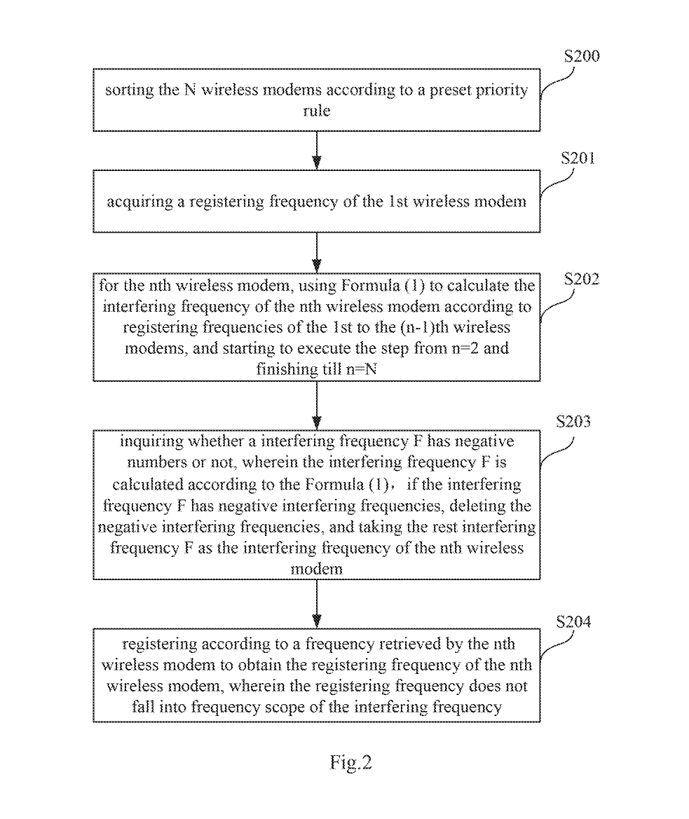

FIG. 2 is a flowchart showing a method for radio frequency control of a multichannel wireless modem according to another embodiment of the present disclosure. As is shown in FIG. 2, the method includes the following steps:

Step S200, sorting the N wireless modems according to a preset priority rule.

Specifically, the preset priority rule can be classifying the wireless modems in the light of functions, setting the priority order according to the classification of functions and sorting the N wireless modems according to the classification of functions.

Step S201, acquiring a registering frequency of the 1st wireless modem.

The N wireless modems are sorted according to the method in Step S200, and the 1st wireless modem registers online, retrieving the registering frequency and allocating a frequency to the 1st wireless modem to acquire the registering frequency of the 1st wireless modem. For example, the acquired registering frequency of the 1st wireless modem is 100.

Step S202, for the nth wireless modem, using an interfering frequency computational formula:

F=a₁f₁±a₂f₂±a₃f₃ . . . ±aₙ₋₁fₙ₋₁ Formula (1)

to calculate the interfering frequency of the nth wireless modem according to registering frequencies of the 1st to the (n−1)th wireless modems, and starting to execute the step from n=2 and finishing till n=N:

Wherein a₁+a₂+a₃ . . . +aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems.

Specifically, for the 2nd wireless modem, the interfering frequency of the 2nd wireless modem can be calculated according to the registering frequency of the 1st wireless modem. In aforesaid formula, a₂, a₃ . . . aₙ₋₁=0, F=a₁, f₁, a₁≦5, , and a₁ is a natural number. Since the frequency cannot be 0, value of a₁ can be 1, 2, 3, 4, and 5, obtaining 5 interfering frequencies. Taking that the acquired registering frequency of the 1st wireless modem is 100 in Step S201 as an example, the interfering frequencies of the 2nd wireless modem are: 100, 200, 300, 400 and 500.

For the 3rd wireless modem, the interfering frequency of the 3rd wireless modem can be calculated according to the registering frequencies of the 1st and 2nd wireless modems. In aforesaid formula, a₃, . . . aₙ₋₁=0, F=a₁f₁±a₂f₂, a₁+a₂≦5, and a₁, a₂ are natural numbers. The interfering frequency of the 3rd wireless modem can be obtained by calculation.

The interfering frequencies of the N modems can be calculated respectively by using aforesaid formula.

Step S203, inquiring whether a interfering frequency F has negative numbers or not, wherein the interfering frequency F is calculated according to the interfering frequency computational formula:

F=a₁f₁±a₂f₂±a₃f₃ . . . ±aₙ₋₁fₙ₋₁ Formula (1)

If the interfering frequency F has negative interfering frequencies, deleting the negative interfering frequencies, and taking the rest interfering frequency F as the interfering frequency of the nth wireless modem.

Wherein a₁+a₂a₃ . . . aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems.

The value of the interfering frequency F calculated by Step S202 might be a negative number, but in practical application, the frequency of a wireless modem cannot be a negative number. Therefore, when the interfering frequencies calculated in Step S202 are negative numbers, the frequencies should be deleted, avoiding that the registering frequency allocated during online registration is negative, thus unable to work properly.

For example, the formula F=a₁f₁−a₂f₂ can be used for calculating the interfering frequency of the 3rd wireless modem. The interfering frequency f₁ of the 1st wireless modem is 100. The interfering frequency of the 2nd wireless modem is 260. When the values of a₁ and a₂ are both 1, the interfering frequency obtained is −160, a negative number, which cannot be applied in practice, thus the frequency should be deleted.

Step S204, registering according to a frequency retrieved by the nth wireless modem to obtain the registering frequency of the nth wireless modem, wherein the registering frequency does not fall into frequency scope of the interfering frequency.

Specifically, the nth wireless modem retrieves the frequencies that can be registered, and in Step S203 the interfering frequency of the nth wireless modem is obtained. Therefore, the registering frequency of the nth wireless modem will not fall into the frequency scope of the interfering frequency, i.e. avoiding registering the interfering frequency.

When the registering frequencies of the modems are close, they are easy to interfere with one another. When the interfering frequency calculated by Step S203 is equal to the registering frequency of the wireless modem, the wireless modem may register a frequency close to other wireless modems to cause interference, though registering a frequency within the scope of interfering frequency is avoided. Thus the registering frequency should not fall into the scope of a preset threshold value frequency band which takes the interfering frequency as center frequency. For example, the interference frequency is 200, the registering frequency should fall into the frequency band scope of 190-210, avoiding that the wireless modem registers a frequency within the frequency band scope. Here is just an illustration, and the scope of the preset threshold value frequency band can be set according to actual requirement in application, and it does not have any restriction.

According to the method. provided by aforesaid embodiment of the present disclosure, the present disclosure calculates the interfering frequency of the nth wireless modem according to the interfering frequency computational formula: F=a₁f₁±a₂f₂±a₃f₃ . . . ±aₙ₋₁fₙ₋₁, wherein a₁+a₂+a₃ . . . +aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems, and inquires whether the interfering frequency has negative numbers, deletes the negative interfering frequencies and takes the rest interfering frequency F as the interfering frequency of the nth wireless modem to avoid that the registering frequency allocated during online registration is negative, thus unable to work properly; registers according to the frequency retrieved by the nth wireless modem to obtain the registering frequency of the nth wireless modem, wherein the registering frequency does not fall into frequency scope of the interfering frequency, which avoids that other wireless modems register a frequency close to some wireless modem to cause mutual interference, the method achieves that the registering frequencies of the N wireless modems are different, thus avoids co-channel interference and frequency doubling interference and improves sensitivity and transmission rate of the multichannel wireless modem.

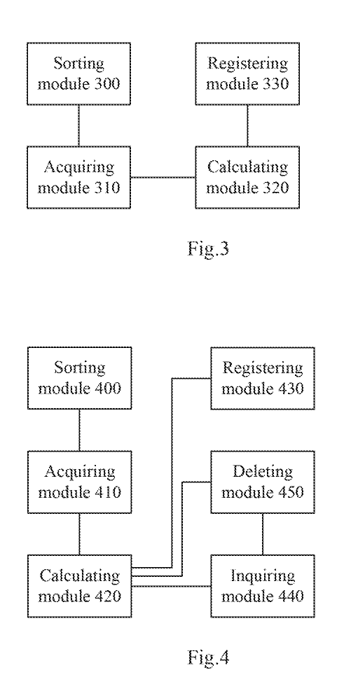

FIG. 3 is a structure diagram of a device for radio frequency control of a multichannel wireless modem according to an embodiment of the present disclosure. The multichannel wireless modem includes N wireless modems. As is shown in FIG. 3, the device includes: a sorting module 300, an acquiring module 310, a calculating module 320 and a registering module 330.

The sorting module 300 is configured to sort the N wireless modems.

The acquiring module 310 is configured to acquire a registering frequency of the 1st wireless modem.

The calculating module 320 is configured to calculate an interfering frequency of the nth wireless modem according to registering frequencies of the 1st to the (n−1)th wireless modems for the nth wireless modem.

The registering module 330 is configured. to register according to a frequency retrieved by the nth wireless modem to obtain the registering frequency of the nth wireless modem, wherein the registering frequency does not fall into frequency scope of the interfering frequency; starting to execute the step from n=2 and finishing till n=N.

According to the device provided by aforesaid embodiment of the present disclosure, sorting the N wireless modems, acquiring the registering frequency of the 1st wireless modem: for the nth wireless modem, calculating the interfering frequency of the nth wireless modem according to registering frequencies of the 1st to the (n−1)th wireless modems, and registering according to a frequency retrieved by the nth wireless modem to obtain the registering frequency of the nth wireless modem, wherein the registering frequency does not fall into frequency scope of the interfering frequency; stalling to execute the step from n=2 and finishing till n=N, the device achieves that the registering frequencies of the N wireless modems are different, thus avoids co-channel interference and frequency doubling interference and improves sensitivity and transmission rate of the multichannel wireless modem.

FIG. 4 is a structure diagram of a device for radio frequency control of a. multichannel wireless modem according to an embodiment of the present disclosure. As is shown in FIG. 4, the device includes: a sorting module 400, an acquiring module 410, a calculating module 420 and a registering module 430.

The sorting module 400 is configured to sort the N wireless modems.

The acquiring module 410 is configured to acquire a registering frequency of the 1st wireless modem.

The calculating module 420 is configured to calculate an interfering frequency of the nth wireless modem according to registering frequencies of the 1st to the (n−1)th wireless modems for the nth wireless modem.

Optionally, the calculating module is further configured to: use an interfering frequency computational formula:

F=a₁f₁±a₂f₂±a₃f₃ . . . ±aₙ₋₁fₙ₋₁ to calculate the interfering frequency of the nth wireless modem according to registering frequencies of the 1st to the (n−1)th wireless modems, wherein a₁+a₂+a₃ . . . +aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems.

The registering module 430 is configured to register according to a frequency retrieved by the nth wireless modem to obtain the registering frequency of the nth wireless modem, wherein the registering frequency does not fall into frequency scope of the interfering frequency.

Starting to execute the calculating module 420 and the registering module 430 from n=2 and finishing till n=N.

Optionally, the registering frequency does not fat into the scope of a preset threshold value frequency band which takes the interfering frequency as center frequency.

Optionally, the device also includes: an inquiring module 440, configured to inquire whether a interfering frequency F has negative numbers or not, wherein the interfering frequency F is calculated according to the interfering frequency computational formula: F=a₁f₁±a₂f₂±a₃f₃ . . . ±aₙ₋₁fₙ₋₁, wherein a₁+a₂+a₃ . . . +aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems;

A deleting module 450, configured to delete the negative interfering frequencies if the interfering frequency has negative numbers, and to take the rest interfering frequency F as the interfering frequency of the nth wireless modem.

Optionally, the sorting module 400 is further configured to: sort the N wireless modems according to a preset priority rule.

According to the device provided by aforesaid embodiment of the present disclosure, the present disclosure calculates the interfering frequency of the nth wireless modem according to the interfering frequency computational formula: F=a₁f₁±a₂f₂±a₃f₃ . . . ±aₙ₋₁fₙ₋₁, wherein a₁+a₂+a₃ . . . +aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems, and inquires whether the interfering frequency has negative numbers, deletes the negative interfering frequencies and takes the rest interfering frequency F as the interfering frequency of the nth wireless modem to avoid that the registering frequency allocated during online registration is negative, thus unable to work properly; registers according to the frequency retrieved by the nth wireless modem to obtain the registering frequency of the nth wireless modem, wherein the registering frequency does not fall into frequency scope of the interfering frequency, which avoids that other wireless modems register a frequency close to some wireless modem to cause mutual interference, the method achieves that the registering frequencies of the N wireless modems are different, thus avoids co-channel interference and frequency doubling interference and improves sensitivity and transmission rate of the multichannel wireless modem.

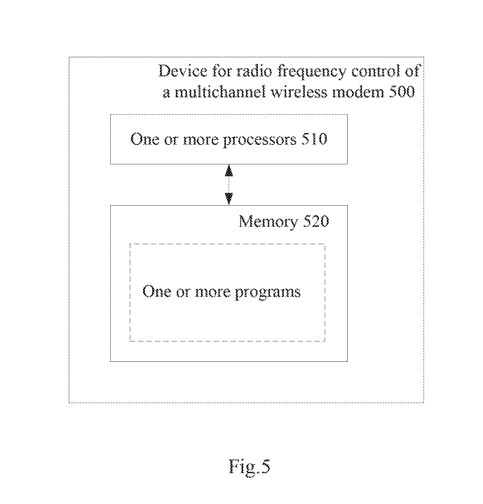

FIG. 5 is a structure diagram of a device for radio frequency control of a multichannel wireless modem according to an embodiment of the present disclosure. The device 500 includes: one or more processors 510; and a memory 520; one or more programs, wherein one or more programs are stored in the memory, and when executed by the one or more processors, the one or more programs cause the one or more processors to perform:

sorting the N wireless modems;

acquiring a registering frequency of the 1st wireless modem;

for the nth wireless modem, calculating an interfering frequency of the nth wireless modem according to registering frequencies of the 1st to the (n−1)th wireless modems, and registering according to a frequency retrieved by the nth wireless modem to obtain a registering frequency of the nth wireless modem, wherein said registering frequency does not fall into a frequency scope of said interfering frequency; starting to execute the step from n=2 and finishing till n=N.

Optionally, the one e processors are further configured to perform:

using an interfering frequency computational formula:

F=a₁f₁±a₂f₂±a₃f₃ . . . ±aₙ₋₁fₙ₋₁ to calculate the interfering frequency of the nth wireless modem according to the registering frequencies of the 1st to the (n−1)th wireless modems, wherein a₁+a₂+a₃ . . . +aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems.

Optionally, the one or more processors are further configured to perform: inquiring whether a interfering frequency F has negative numbers or not, wherein the interfering frequency F is calculated according to the interfering frequency computational formula: F=a₁f₁±a₂f₂±a₃f₃ . . . ±aₙ₋₁fₙ₋₁, wherein a₁+a₂+a₃ . . . +aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems, and if the interfering frequency has negative numbers, deleting the negative interfering frequencies, and taking the rest interfering frequency F as the interfering frequency of the nth wireless modem.

Optionally, that the one or processors are configured to perform:

for the nth wireless modem, calculating an interfering frequency of the nth wireless modem according to registering frequencies of the 1st to the (n−1)th wireless modems, and registering according to a frequency retrieved by the nth wireless modem to obtain a registering frequency of the nth wireless modem, wherein said registering frequency does not fall into a scope of a preset threshold value frequency band which takes said interfering frequency as a center frequency.

Optionally, the one or processors are configured to perform:

sorting the N wireless modems according to a preset priority rule.

The above description has presented and illustrated many exemplary embodiments of the present disclosure, and however, as stated above, it shall be appreciated that the present disclosure is not limited to the implementations disclosed herein, providing these exemplary embodiments shall not be deemed as excluding other embodiments. Instead, the technical solutions in the present disclosure may be applied in any other combinations, variations and environments, and may be modified based on the above teaching or technologies or knowledge in related fields within the conceiving scope of the present disclosure. Any modifications or changes performed by one of ordinary skill in this art without departing from the spirit and scope of the present disclosure shall fail within the protection scope as defined by appended claims.

1. A method for radio frequency control of a multichannel wireless modem, wherein said multichannel wireless modem comprises N wireless modems, and said method comprises:
sorting the N wireless modems;
acquiring a registering frequency of the 1st wireless modem; and
for the nth wireless modem, calculating an interfering frequency of the nth wireless modem according to registering frequencies of the 1st to the (n−1)th wireless modems, and registering according to a frequency retrieved by the nth wireless modem to obtain a registering frequency of the nth wireless modem, wherein said registering frequency does not fall into a frequency scope of said interfering frequency; starting to execute the step from n=2 and finishing till n=N.

2. The method according to claim 1, wherein said calculating an interfering frequency of the nth wireless modem according to registering frequencies of the 1st to the (n−1)th wireless modems further comprises:
using an interfering frequency computational formula:
F=a₁f₁±a₂f₂±a₃f₃ . . . ±aₙ₋₁fₙ₋₁ to calculate the interfering frequency of the nth wireless modem according to the registering frequencies of the 1st to the (n−1)th wireless modems, wherein a₁+a₂+a₃ . . . aₙ₋≦5, a₁, a₁, a₂ , a₃ . . . aₙ₋₁ are natural numbers and f₁, f₂, f₃ . . . fₙ₋₁ are the registering frequencies of the 1st to the (n−1)th wireless modems.

3. The method according to claim 2, wherein said method also comprises: inquiring whether a interfering frequency F has negative numbers or not, wherein the interfering frequency F is calculated according to the interfering frequency computational formula: F=a₁f₁±a₂f₂±a₃f₃ . . . ±aₙ₋₁fₙ₋₁, wherein a₁+a₂+a₃ . . . aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems, and if the interfering frequency has negative numbers, deleting the negative interfering frequencies, and taking the rest interfering frequency F as the interfering frequency of the nth wireless modem.

4. The method according to claim 1, wherein said registering frequency does not fall into a frequency scope of said interfering frequency further comprises that:
said registering frequency does not fall into a scope of a preset threshold value frequency band which takes said interfering frequency as a center frequency.

5. The method according to claim 1, wherein said sorting the N wireless modems further comprises:
sorting the N wireless modems according to a preset priority rule.

6. A device for radio frequency control of a multichannel wireless modem, wherein said multichannel wireless modem comprises N wireless modems, and said device comprises:
one or more processors; and
a memory; and
one or more programs, wherein one or more programs are stored in the memory, and when executed by the one or more processors, the one or more programs cause the one or more processors to perform:
sorting the N wireless modems;
acquiring a registering frequency of the 1st wireless modem;
for the nth wireless modem, calculating an interfering frequency of the nth wireless modem according to registering frequencies of the 1st to the (n−1)th wireless modems, and registering according to a frequency retrieved by the nth wireless modem to obtain a registering frequency of the nth wireless modem, wherein said registering frequency does not fall into a frequency scope of said interfering frequency; starting to execute the step from n=2 and finishing till n=N.

7. The device according to claim 6, wherein the one or more processors are further configured to perform:
using an interfering frequency computational formula:
F=a₁f₁±a₂f₂±a₃f₃ . . . ±aₙ₋₁fₙ₋₁ to calculate the interfering frequency of the nth wireless modem according to the registering frequencies of the 1st to the (n−1)th wireless modems, wherein a₁+a₂+a₃ . . . +aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems.

8. The device according to claim 7, characterized in wherein the one or more processors are further configured to perform:
inquiring whether a interfering frequency F has negative numbers or not, wherein the interfering frequency F is calculated according to the interfering frequency computational formula: F=a₁f₁±a₂f₂±a₃f₃ . . . ±aₙ₋₁fₙ₋₁, wherein a₁+a₂+a₃ . . . +aₙ₋₁≦5, a₁, a₂, a₃ . . . aₙ₋₁ are natural numbers and f₁, f₂, f₃ . . . fₙ₋₁ are the registering frequencies of the 1st to the (n−1)th wireless modems, and if the interfering frequency has negative numbers, deleting the negative interfering frequencies, and taking the rest interfering frequency F as the interfering frequency of the nth wireless modem.

9. The device according to claim 6, wherein the one or more processors are configured to perform:
for the nth wireless modem, calculating an interfering frequency of the nth wireless modem according to registering frequencies of the 1st to the (n−1)th wireless modems, and registering according to a frequency retrieved by the nth wireless modem to obtain a registering frequency of the nth wireless modem, wherein said registering frequency does not fall into a scope of a preset threshold value frequency band which takes said interfering frequency as a center frequency.

10. The device according to claim 6, wherein the one or more processors are configured to perform:
sorting the N wireless modems according to a preset priority rule.
